(19) United States
(12) Patent Application Publication
(10) Pub. No.: US 2017/0226795 A1
(43) Pub. Date: Aug. 10, 2017

(54) DRIVING DEVICE FOR A WINDOW BLIND

(71) Applicant: TAICANG KINGFU PLASTIC MANUFACTURE CO., LTD, Jiangshu Province (CN)

(72) Inventor: Szu-Chang Huang, Fusing Township (TW)

(21) Appl. No.: 15/453,080

(22) Filed: Mar. 8, 2017

Related U.S. Application Data
(63) Continuation-in-part of application No. 15/178,959, filed on Jun. 10, 2016.

(30) Foreign Application Priority Data
Feb. 5, 2016 (CN) 201620114613.2
Dec. 16, 2016 (CN) 201621389709.6

(51) Int. Cl. E06B 9/322; E06B 9/264

(52) U.S. Cl. CPC E06B 9/322; E06B 9/264; E06B 2009/2435

(57) ABSTRACT

A driving device is for a window blind. The driving device includes a mounting frame disposed between parallel first and second plates of the window blind, and first and second transmission members. The first transmission member has an inner magnetic portion and a worm portion. The inner magnetic portion is adapted to be disposed adjacent to the first plate, and is rotatable under influence of a magnetic force from a side of the first plate. The worm portion is co-rotatably connected to the inner magnetic portion. The second transmission member has a worm gear portion meshing with the worm portion, and a driving rod connected to the window blind so as to be driven rotatably by the first transmission member to operate the window blind.

### CROSS-REFERENCE TO RELATED APPLICATION

This application is a continuation-in-part (CIP) of co-pending U.S. patent application Ser. No. 15/178,959, filed on Jun. 10, 2016, and claims priorities of Chinese Patent Application No. 201620114613.2, filed on Feb. 5, 2016, and Chinese Patent Application No. 201621389709.6, filed on Dec. 16, 2016.

### FIELD

The disclosure relates to a driving device, and more particularly to a driving device for a window blind.

### BACKGROUND

A conventional window blind includes two parallel glass plates and a blind unit disposed therebetween. The blind unit includes a top frame, and two side frames that extend downward from two opposite ends of the top frame, respectively. A conventional driving device for driving operation of the blind unit includes a control member disposed in the top frame and connected to the blind unit, and is provided with an drive member disposed in one of the side frames, connected to the control member, and being operable to drive rotation of the control member for operation of the blind unit.

With such design, the one of the side frames in which the drive member is disposed has to be large enough for accommodating the drive member therein. If the other one of the side frames is made smaller, the window blind is asymmetric and may be perceived to be aesthetically unpleasant. If both of the side frames are made to have the same size for symmetrical consideration, the manufacturing cost is higher due to an increase in the amount of raw material used. Therefore, there is room for improving the conventional driving device.

### SUMMARY

Therefore, an object of the disclosure is to provide a driving device that can alleviate at least one of the drawbacks of the prior art.

According to the disclosure, the driving device is for a window blind. The window blind includes a first plate and a second plate that are parallelly disposed, and a blind unit that is disposed between the first and second plates. The driving device includes a mounting frame, first transmission member, and a second transmission member.

The mounting frame is adapted to be disposed between the first and second plates of the window blind. The first transmission member has an inner magnetic portion and a worm portion. The inner magnetic portion is adapted to be disposed adjacent to the first plate, and is rotatable about a first axis which is normal to the first plate under influence of a magnetic force from a side of the first plate opposite to the second plate. The worm portion is supported by the mounting frame, and is co-rotatable connected to the inner magnetic portion. The second transmission member has a worm gear portion and a driving rod. The worm gear portion is mounted to the mounting frame, and meshes with the worm portion of the first transmission member such that rotation of the worm portion of the first transmission member about the first axis drives the worm gear portion to rotate about a second axis which is perpendicular to the first axis. The driving rod is co-rotatably coupled to the worm gear portion, and is adapted to be connected to the blind unit of the window blind for operation of the blind unit.

### BRIEF DESCRIPTION OF THE DRAWINGS

Other features and advantages of the disclosure will become apparent in the following detailed description of the embodiments with reference to the accompanying drawings, of which:

FIG. 1 is a partly exploded perspective view of a first embodiment of a driving device according to the disclosure mounted to a window blind;

FIG. 2 is a fragmentary perspective view illustrating the first embodiment;

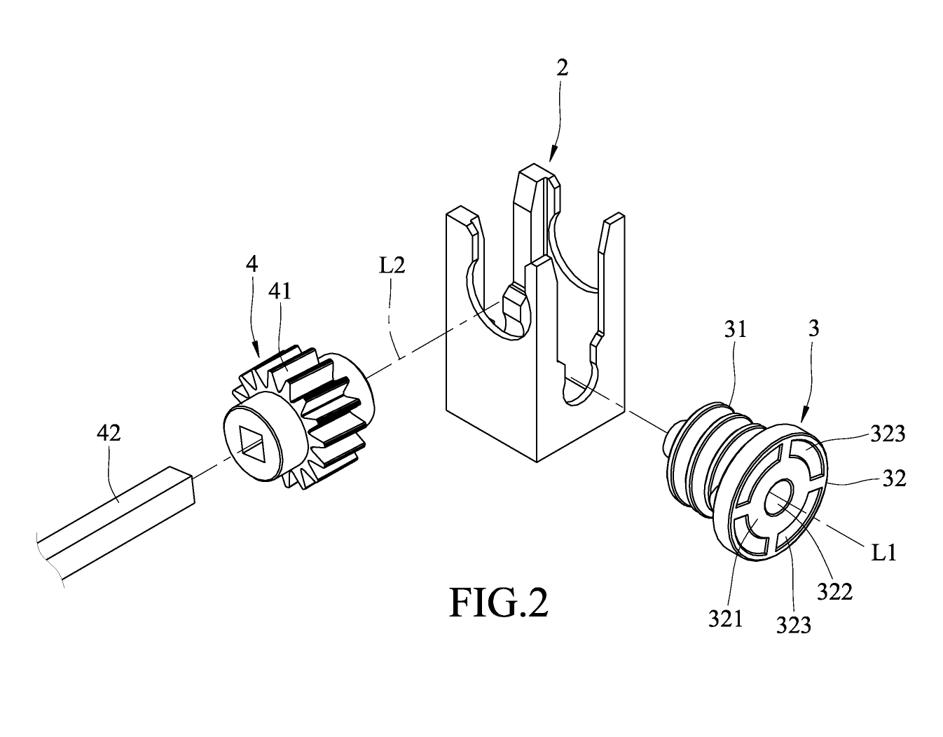

FIG. 3 is a fragmentary sectional view of the first embodiment and the window blind;

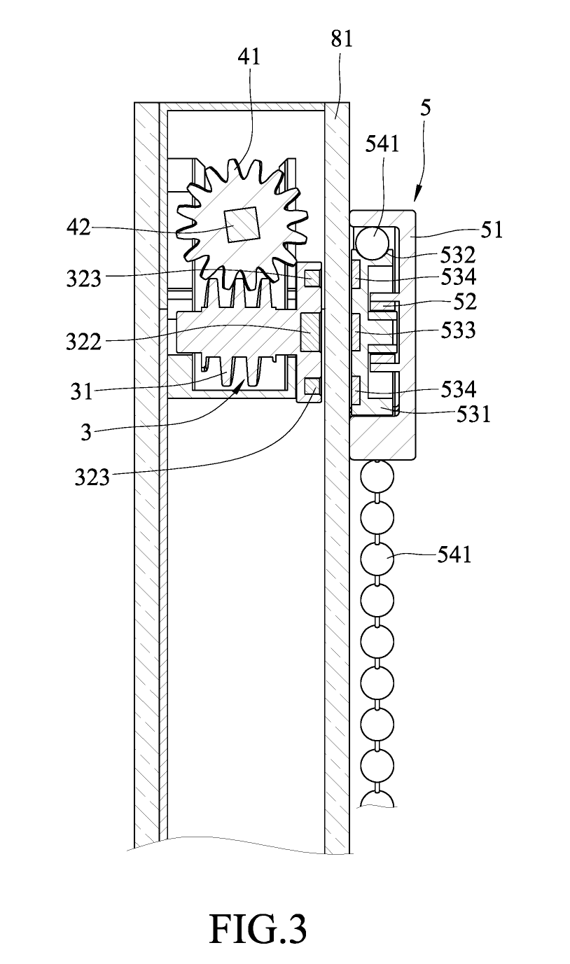

FIG. 4 is a partly exploded perspective view of a second embodiment of the driving device according to the disclosure mounted to a window blind;

FIG. 5 is a fragmentary sectional view of the second embodiment and the window blind;

FIG. 6 is a partly exploded perspective view of a third embodiment of the driving device according to the disclosure mounted to a window blind; and

FIG. 7 is a fragmentary sectional view of the third embodiment and the window blind.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Referring to FIGS. to 3, a first embodiment of a driving device according to the disclosure is for a window blind 8. The window blind 8 includes a first plate 81 and a second plate 82 that are parallelly disposed and that are made of glass, and a blind unit 83 that is disposed between the first and second plates 81, 82. The driving device includes a mounting frame 2, a first transmission member 3, a second transmission member 4, and a first drive member 5.

The mounting frame 2 is disposed between the first and second plates 81, 82 of the window blind 8.

The first transmission member 3 has an inner magnetic portion 32 and a worm portion 31. The inner magnetic portion 32 is adapted to be disposed adjacent to the first plate 81, and is rotatable about a first axis (L1) which is normal to the first plate 81 under influence of a magnetic force from a side of the first plate 81 opposite to the second plate 82. The worm portion 31 is supported by the mounting frame 2, and is co-rotatably connected to the inner magnetic portion 32.

In greater detail, the inner magnetic portion 32 of the first transmission member 3 includes a plate body 321 connected to the worm portion 31, a first magnet 322 mounted to the plate body 321 and disposed adjacent to the first plate 81, and four second magnets 323 mounted to the plate body 321 and surrounding the first magnet 322.

The second transmission member 4 has a worm gear portion 41 and a driving rod 42. The worm gear portion 41 is mounted to the mounting frame 2, and meshes with the worm portion 31 of the first transmission member 3 such that rotation of the worm portion 31 of the first transmission member 3 about the first axis (L1) drives the worm gear portion 41 to rotate about a second axis (L2) which is perpendicular to the first axis (L1). The driving rod 42 is co-rotatably coupled to the worm gear portion 41, and is adapted to be connected to the blind unit 83 of the window blind 8 for operation of the blind unit 83.

The first drive member 5 is removably disposed at the side of the first plate 81 opposite to the second plate 82, and has a shell body 51, a bearing 52, a rotatable outer magnetic portion 53, and an operating portion 54. The bearing 52 is disposed in the shell body 51. The rotatable outer magnetic portion 53 is supported by the bearing 52, and is magnetically attracted to the inner magnetic portion 32 for providing the magnetic force so that rotation of the outer magnetic portion 53 drives the rotation of the inner magnetic portion 32 about the first axis (L1). In greater detail, the outer magnetic portion 53 has a rotatable main body 531 supported by the bearing 52, a third magnet 533 mounted to the main body 531 and magnetically attracted to and facing the first magnet 322, and four fourth magnets 534 mounted to the main body 531, and magnetically and respectively attracted to the second magnets 323.

The main body 531 of the outer magnetic portion 53 of the first drive member 5 is formed with a plurality of angularly spaced-apart receiving holes 532. The operating portion 54 is connected to the outer magnetic portion 53, and is operable to drive the rotation of the outer magnetic portion 53. Specifically, the operating portion 54 is configured as a chain that has a plurality of beads 541 connected to one another. A portion of the beads 541 are received removably in the receiving holes 532 for driving rotation of the outer magnetic portion 53 when the operating portion 54 is pulled.

When in use, the first drive member 5 is first disposed on the first plate 81 of the window blind 8 for the third and fourth magnets 533, 534 to be respectively and magnetically attracted to the first and second magnets 322, 323, such that the shell body 51 of the first drive member 5 is attached onto the first plate 81. By pulling the operating portion 54, the third and fourth magnets 533, 534 of the outer magnetic portion 53 are rotated to drive the first and second magnets 322, 323 to rotate via the magnetic force generated between the first and third magnets 322, 533 and between the second and fourth magnets 323, 534. Rotation of the first and second magnets 322, 323 drives the worm portion 31 of the first transmission member 3 to co-rotate therewith to thereby rotate the worm gear portion 41 of the second transmission member 4 for operation of the blind unit 83 via the driving rod 42.

Since the first drive member 5 is removably disposed on an outer side of the first plate 81 and does not have to be assembled in the window blind 8, the window blind 8 can be designed to be relatively compact, which may reduce manufacturing costs o In addition, since the first drive member 5 is needed only for operation of the blind unit 83, the first drive member 5 can be stored in a proper place when not in use, which effectively reduces the chance of damage to the first drive member 5.

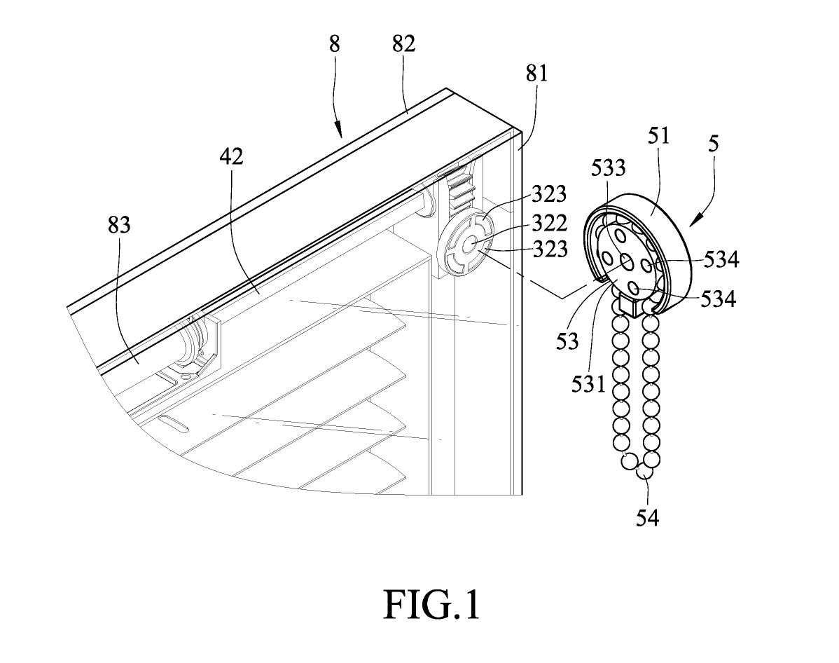

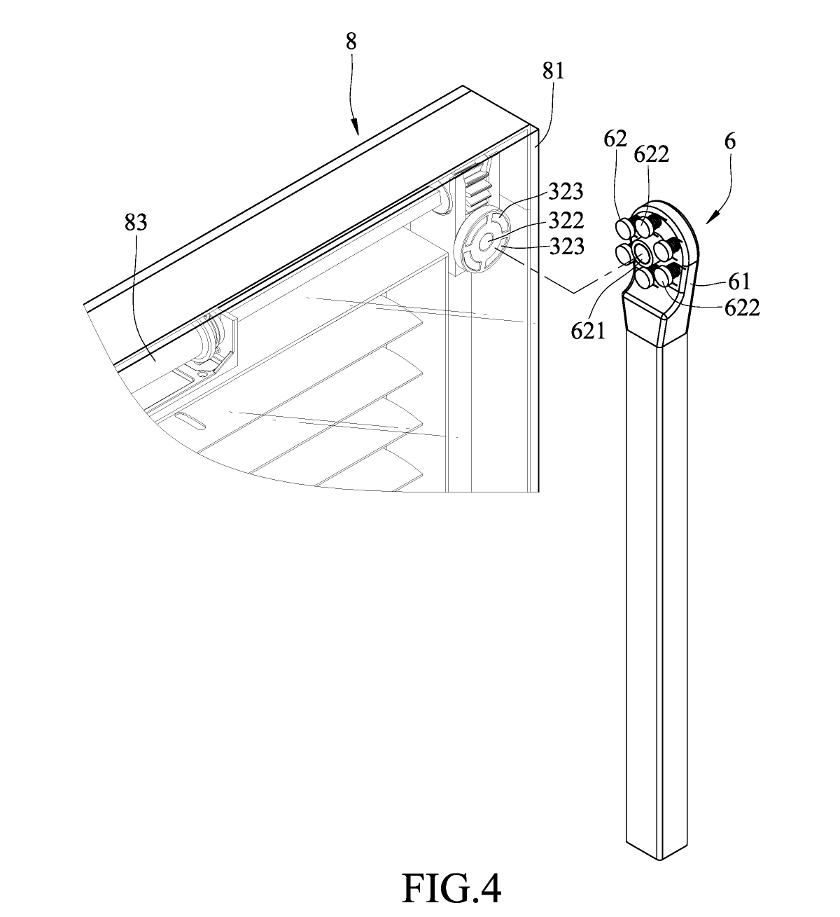

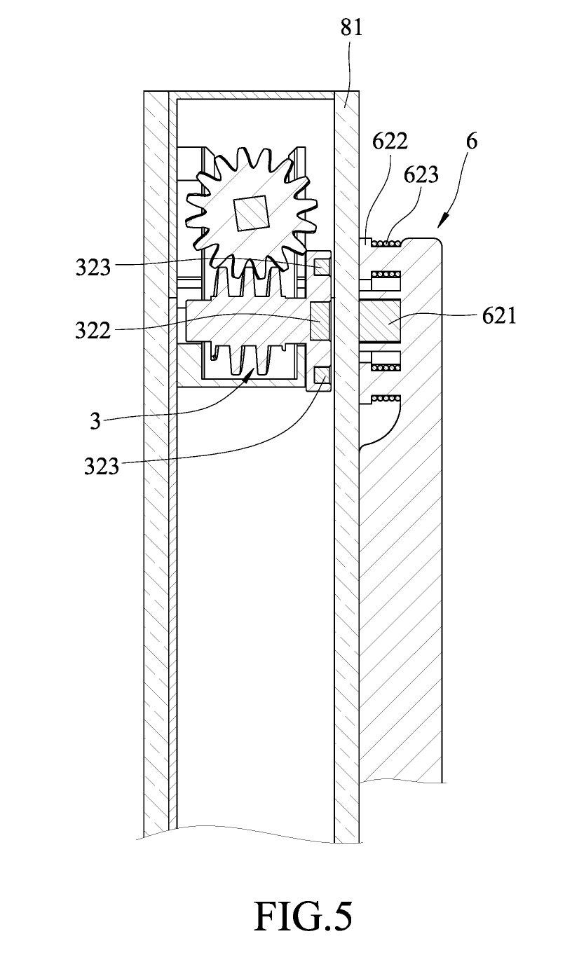

Referring to FIGS. 4 and 5, a second embodiment of the driving device according to the disclosure is similar to the first embodiment . in the second embodiment, the first drive member 5 (see FIG. 1) is substituted by a second drive member 6. The second drive member 6 is removably disposed at the opposite side of the first plate 81 opposite to the second plate 82, and has a pole body 61 and an cuter magnetic portion 62. The outer magnetic portion 62 is connected to the pole body 61, and includes a fifth magnet 621 magnetically attracted to the first magnet 322, and six electromagnets 622 surrounding the fifth magnet 621 and operable to generate an electromagnetic force for providing the magnetic force to drive the rotation of the inner magnetic portion 32 of the first transmission member 3 about the first axis (L1). Each of the electromagnets 622 has an electromagnetic coil 623.

When in use, first the fifth magnet 621 is disposed to be magnetically attracted to and facing the first magnet 322 so that the outer magnetic portion 62 of the second drive member 6 is attached to the first plate 81 of the window blind 8. Next, an electric current is supplied to the electromagnets 622 so as to produce the magnetic force to drive the rotation of the first and second magnets 323.

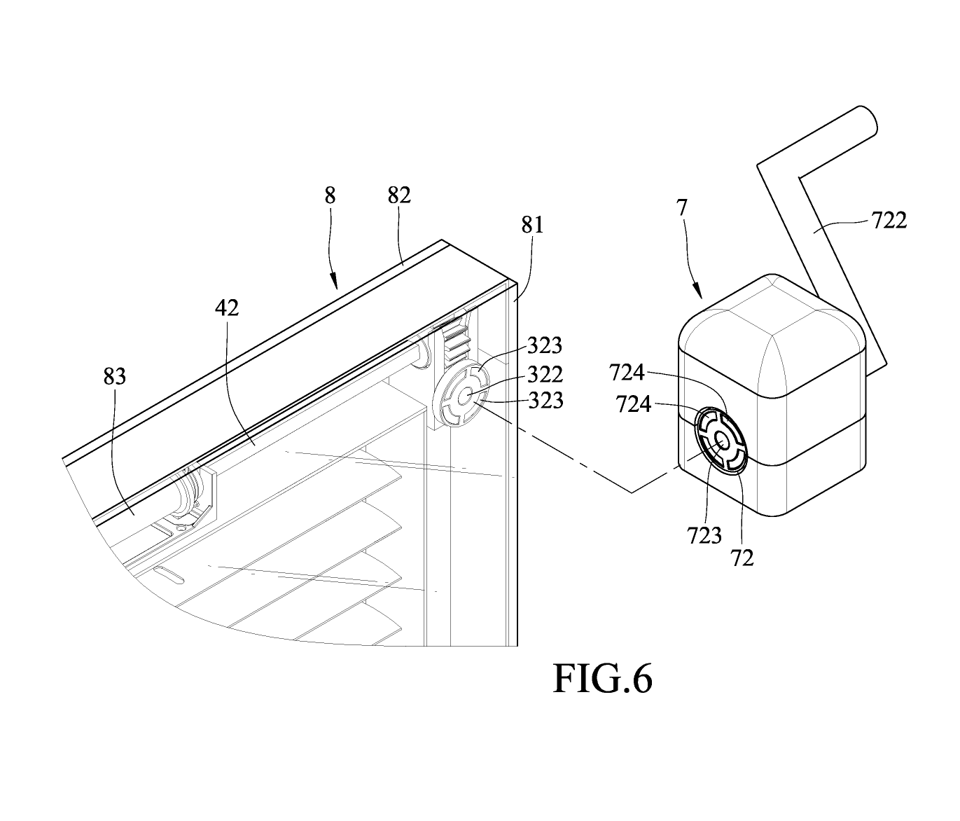

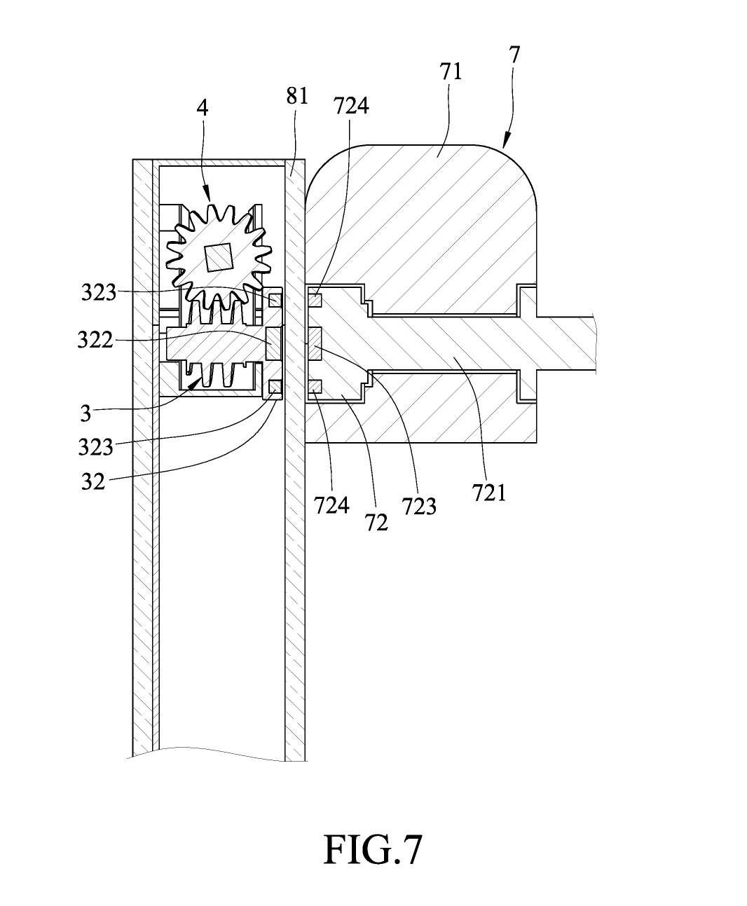

Referring to FIGS. 6 and 7, a third embodiment of the driving device according to the disclosure is similar to the first embodiment. In the third embodiment, the first drive member 5 (see FIG. 1) is substituted by a third drive member 7. The third drive member 7 is removably disposed at the side of the first plate 81 opposite to the second plate 82, and has a shell body 71 and an outer magnetic portion 72. The outer magnetic portion 72 includes a main body 721 disposed rotatably in the shell body 71, a drive arm 722 co-rotatably connected to the main body 721, a sixth magnet 723 mounted to the main body 721 and magnetically attracted to the first magnet 322, and four seventh magnets 724 mounted to the main body 721 and magnetically attracted to the second magnets 323 for providing the magnetic force. By rotating the drive arm 722, the main body 721 of the outer magnetic portion 72 of the third drive member 7 is rotated to drive rotation of the sixth and seventh magnets 723, 724, so as to drive the rotation of the first and second magnets 322, 323 of the inner magnetic portion 32 about the first axis (L1).

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A driving device for a window blind, the window blind including a first plate and a second plate that are parallelly disposed, and a blind unit that is disposed between the first and second plates, said driving device comprising:
a mounting frame adapted to be disposed between the first and second plates of the window blind;
a first transmission member having
an inner magnetic portion that is adapted to be disposed adjacent to the first plate, and that is rotatable about a first axis which is normal to the first plate under influence of a magnetic force from a side of the first plate opposite to the second plate, and
a worm portion that is supported by said mounting frame, and that is co-rotatably connected to said inner magnetic portion; and
a second transmission member having
a worm gear portion that is mounted to said mounting frame, and that meshes with said worm portion of said first transmission member such that rotation of said worm portion of said first transmission member about the first axis drives said worm gear portion to rotate about a second axis which is perpendicular to the first axis, and
a driving rod that is co-rotatably coupled to said worm gear portion and that is adapted to be connected to the blind unit of the window blind for operation of the blind unit.

2. The driving device as claimed in claim 1, wherein said inner magnetic portion of said first transmission member includes a plate body connected to said worm portion, a first magnet mounted to said plate body and adapted to be disposed adjacent to the first plate, and a plurality of second magnets mounted to said plate body and surrounding said first magnet.

3. The driving device as claimed in claim 2, further comprising a drive member adapted to be removably disposed at the side of the first plate opposite to the second plate, and having
a shell body,
a bearing that is disposed in said shell body,
a rotatable outer magnetic portion that is supported by said bearing, and that is magnetically attracted to said inner magnetic portion for providing the magnetic force so that rotation of said outer magnetic portion drives the rotation of said inner magnetic portion about the first axis, and
an operating portion that is connected to said outer magnetic portion and that is operable to drive the rotation of said outer magnetic portion.

4. The driving device as claimed in claim 3, wherein said outer magnetic portion of said drive member has a rotatable main body supported by said bearing, a third magnet mounted to said main body and magnetically attracted to said first magnet, and a plurality of fourth magnets mounted to said main body, and magnetically and respectively attracted to said second magnets.

5. The driving device as claimed in claim 4, wherein said main body of said outer magnetic portion of said drive member is formed with a plurality of angularly spaced-apart receiving holes, said operating portion being configured as a chain that has a plurality of beads connected to one another, a portion of said heads being received removably in said receiving holes for driving rotation of said outer magnetic portion when said operating portion is pulled.

6. The driving device as claimed in claim 2, further comprising a drive member adapted to be removably disposed at the opposite side of the first plate opposite to the second plate, and having
a pole body, and
an outer magnetic portion that is connected to said pole body, and that includes a fifth magnet magnetically attracted to said first magnet, and a plurality of operable to generate an electromagnetic force for providing the magnetic force to drive the rotation of said inner magnetic portion of said first transmission member about the first axis.

7. The driving device as claimed in claim 6, wherein each of said electromagnets has an electromagnetic coil.

8. The driving device as claimed in claim 2, further comprising a drive member adapted to be removably disposed at the side of the first plate opposite to the second plate, and having
a shell body, and
an outer magnetic portion that includes a main body disposed rotatably in said shell body, a drive arm co-rotatably connected to said main body, a sixth magnet mounted to said main body and magnetically attracted to said first magnet, and a plurality of seventh magnets mounted to said main body and magnetically attracted to said second magnets for providing the magnetic force so that rotation of said drive arm results in rotation of said main body and drives the rotation of said inner magnetic portion about the first axis.

9. A driving device for a window blind, the window blind including a first plate and a second plate that are parallelly disposed, and a blind unit that is disposed between the first and second plates, said driving device comprising:
a mounting, frame adapted to be disposed between the first and second plates of the window blind;
a first transmission member having
an inner magnetic portion that is adapted to be disposed adjacent to the first plate, and that is rotatable about a first axis which s normal to the first plate under influence of a magnetic force from a side of the first plate opposite to the second plate, and
a worm portion that is supported by said mounting frame, and that is co-rotatably connected to said inner magnetic portion;
a second transmission member having
a worm gear portion that is mounted to said mounting frame, and that meshes with said worm portion of said first transmission member such that rotation of said worm portion of said first transmission member about the first axis drives said worm gear portion to rotate about a second axis which is perpendicular to the first axis, and
a driving rod that is co-rotatably coupled to said worm gear portion and that is adapted to be connected to the blind unit of the window blind for operation of the blind unit; and
a drive member adapted to be removably disposed at the side of the first plate opposite to the second plate, and having an outer magnetic portion disposed to provide the magnetic force.

10. The driving device as claimed in claim 9, wherein said inner magnetic portion of said first transmission member includes a plate body connected to said worm portion, a first magnet mounted to said plate body and adapted to be disposed adjacent to the first plate, and a plurality of second magnets mounted to said plate body and surrounding said first magnet.

11. The driving device as claimed in claim 10, wherein:
said drive member further has a shell body, a bearing that is disposed in said shell body, and an operating portion;
said outer magnetic portion is supported by said bearing, and is magnetically attracted to said inner magnetic portion for providing the magnetic force so that rotation of said outer magnetic portion drives the rotation of said inner magnetic portion about the first axis; and
said operating portion is connected to said outer magnetic portion and is operable to drive the rotation of said outer magnetic portion.

12. The driving device as claimed in claim 11, wherein said outer magnetic portion of said drive member has a rotatable main body supported by said bearing, a third magnet mounted to said main body and magnetically attracted to said first magnet, and a plurality of fourth magnets mounted to said main body, and magnetically and respectively attracted to said second magnets.

13. The driving device as claimed in claim 12, wherein said main body of said outer magnetic portion of said drive member is formed with a plurality of angularly spaced-apart receiving holes, said operating portion being configured as a chain that has a plurality of beads connected to one another, a portion of said beads being received removably in said receiving holes for driving rotation of said outer magnetic portion when said operating portion is pulled.

14. The driving device as claimed in claim 10, wherein said drive member further has a pole body, said outer magnetic portion being connected to said pole body, and including a fifth magnet that is magnetically attracted to said first magnet, and a plurality of electromagnets that surrounds said fifth magnet and that is operable to generate an electromagnetic force for providing the magnetic force to drive the rotation of said inner magnetic portion of said first transmission member about the first axis.

15. The driving device as claimed in claim 11, wherein each of said electromagnets has an electromagnetic coil.

16. The driving device as claimed in claim 10, wherein:
said drive member further has a shell body; and
said outer magnetic portion includes a main body disposed rotatably in said shell body, a drive arm co-rotatably connected to said main body, a sixth magnet mounted to said main body and magnetically attracted to said first magnet, and a plurality of seventh magnets mounted to said main body and magnetically attracted to said second magnets for providing the magnetic force so that rotation of said drive arm results in rotation of said main body and drives the rotation of said inner magnetic portion about the first axis.
